(19) United States
(12) Patent Application Publication
(10) Pub. No.: US 2015/0197591 A1
(43) Pub. Date: Jul. 16, 2015

(54) RESINS BEARING CYCLIC CARBONATE GROUPS AND CROSS-LINKABLE COMPOSITIONS OF SAID RESINS HAVING A LOW VOC LEVEL

(71) Applicant: Arkema France, Colombes (FR)

(72) Inventors: Aurelie Pierre, Paris (FR); Frank Cogordan, Paris (FR); Gregory A. Delmas, Senlis (FR)

(21) Appl. No.: 14/405,173

(22) PCT Filed: Jun. 6, 2013
(86) PCT No.: PCT/FR2013/051289

§ 371 Date: Dec. 3, 2014

(30) Foreign Application Priority Data
Jun. 7, 2012 (FR) 1255335

(51) Int. Cl. C08F 220/28; C09D 133/14

(52) U.S. Cl. CPC C08F 220/28; C09D 133/14; C08F 2220/282

(57) ABSTRACT

The invention concerns a resin bearing cyclic carbonate groups, said resin being an oligomer and/or polymer made from a mixture a) of monomers comprising a1) at least one monomer chosen from the (meth)acrylic esters from a C₁ to C18 aliphatic alcohol, a2) at least one ethylenically unsaturated a2.1) or a2.2) monomer where a2.1) is a (meth)acrylic, vinyl or allylic bearer of at least one cyclic carbonate group and where a2.2) is a (meth)acrylic, vinyl or allylic bearer of at least one reactive precursor group of a cyclic carbonate group, a3) at least one ethylenically unsaturated monomer comprising, according to a3.1) at least one cycloaliphatic structure or one heterocyclic structure having 5 or 6 atoms and/or according to a3.2) at least one branched aliphatic structure comprising at least 4 and up to 18 carbon atoms with at least one quaternary carbon and, optionally, a4) at least one aromatic vinyl monomer, optionally, a5): a monomer bearing a carboxy group present in said oligomer or polymer. The invention also covers a method for preparing cross-linkable compositions comprising said resin with, as a cross-linking agent, a polyamine for applying coatings, a use in cross-linked polyurethanes without using isocyanate and the cross-linked polyurethane resulting from said resin of the invention.

The present invention relates to a specific resin, in particular an acrylic resin, bearing cyclic carbonate groups, to a preparation process and to crosslinkable compositions in particular coating compositions comprising said resin for the preparation of crosslinked polyurethanes without any use of isocyanate, said compositions having a high solids content and a low content of volatile organic compounds VOC.

More particularly, the present invention relates to the production of crosslinked polyurethanes (PU) from a reactive but isocyanate-free two-pack system based on the resin of the invention in organic solvent medium (the term “solvent-based” will also be used) and using polyamines as alternative crosslinking agents.

In general, it is well known how to obtain crosslinked polyurethanes from a two-pack system in an organic solvent using a polyol resin by reaction with a polyisocyanate. More particularly, acrylic polyols are preferred for coating applications given their better performance qualities in particular with regard to aging. These polyols are copolymers of a mixture of acrylic monomers comprising a hydroxyalkyl acrylate monomer such as hydroxyethyl(meth)acrylate (HE(M)A) or hydroxypropyl(meth)acrylate.

The essential drawback of these prior-art systems is linked to the fact that an isocyanate (polyisocyanate) is essential as crosslinking agent for these crosslinked polyurethane two-pack systems based on acrylic polyol resins. However, this use poses problems in terms of toxicity, safety and harmfulness to human health and to the environment in general, these problems imposing heavy constraints regarding their handling, which thus becomes increasingly complicated and expensive. Given their toxicity and their preparation from starting materials that are also toxic and harmful to the environment, such as phosgene with emission of hydrochloric acid which is also harmful to the environment, this chemistry, based on the use of isocyanates, needs to be replaced with solutions that are friendlier to man and the environment and which respect the environment and human health, such as sustainable development from novel starting materials that allow the same.

Moreover, in addition to the health and environmental problem, the use of a polyol-isocyanate crosslinkable system is sensitive to the intrinsic moisture of the polyol resin which needs to be dried with a controlled moisture content before use in order to take into account any excess isocyanate to compensate for the consumption of isocyanate by this moisture content.

Next, the temperature and ambient humidity conditions during the application of coatings based on such a system containing an isocyanate are imposed by the climatic coatings based on such a system containing an isocyanate are imposed by the climatic conditions, which are external to the system and uncontrollable. The effect of this is the difficulty and the impossibility in controlling the consumption of isocyanate by the ambient humidity and thus the final structure of the coating obtained (crosslinking density) and of the final performance qualities associated with this structure. In order to make up for this consumption, an excess of isocyanate may be envisaged, but with an overconsumption of isocyanate which may remain free for a certain time in the system before consumption by the ambient humidity with side reactions (decarboxylation and formation of polyamines converted into polyureas) which may affect the structure and performance qualities of the final coating. In particular, the evolution of CO₂ leads to the formation of bubbles (defects) in the final coating, in particular in the case of thick coatings. The other drawback of isocyanates in these coatings is their high impact on the cost price.

Novel two-pack systems are already known from the prior art without using a polyisocyanate (known as NIPU: non-isocyanate PU), for replacing PU systems based on polyol-polyisocyanate. They are based on resins bearing cyclic carbonate groups that are crosslinkable with a polyamine.

More particularly, BE 1 009 543 describes a system based on carbonate functionalized acrylic resin with crosslinking with a primary polyamine for clear coat applications.

EP 0 394 786 describes a system based on a composition consisting of carbonate functionalized copolymers, a blocked polyamine, a catalyst and/or other additives.

WO 2011035 982 describes a system based on hydrodispersible acrylic resins with carbonate functionality for crosslinking with polyamines, the synthesis being performed in solvent medium, for an application in adhesives, mastics and coatings and in particular for anticorrosion protection. The very good chemical resistance of this system constitutes its main advantage, along with its absence of water sensitivity.

Although such a system makes it possible in principle to obtain polyurethanes (PU) without using a polyisocyanate, several additional problems need to be overcome in addition to those mentioned. In particular, in solvent medium, an acrylic resin bearing cyclic carbonate functions has a much higher viscosity than an equivalent hydroxylated resin for the same mass content of monomer bearing the corresponding function, which means a significantly higher viscosity for the same molar content (or same index expressed as equivalents mg KOH/g). The consequence of this is the limitation of the solids content in the crosslinkable composition, in order to be able to keep a constant and suitable viscosity, which is an essential parameter for coating applications.

At a time when the regulations regarding the reduction of VOCs are becoming stricter, no solutions that satisfy this problem are known in the prior art. Thus, there is a need for novel carbonate functionalized resins, in particular acrylic resins, allowing the formation of coatings and in particular paints or varnishes with a low content of VOC and with a high solids content and a viscosity that is suited to the application of coatings in organic solvent medium.

Thus, the problem consists first in finding a specifically selected resin without the need to use isocyanates, bearing cyclic carbonate groups having a sufficiently reduced viscosity in organic solvent medium, to allow a specific two-pack system, which is room-temperature crosslinkable, preferably from −20 to 25° C. with a polyamine as crosslinking agent having a low content of VOC, preferably less than 420 WI for compounds with a boiling point of less than 250° C. and a high solids content, dependent on the application, without affecting the targeted viscosity for application in coatings crosslinkable in solvent medium. This specific system as targeted should be a novel polyurethane two-pack system that is crosslinkable without any use of isocyanate and, as a result and due to the reduced content of VOC, it should be friendly to the environment and to health, and in particular should be insensitive to the intrinsic humidity of the resin or the ambient humidity during the application of the coating and should have performance qualities for the polyurethane coatings thus obtained, that are at least not affected (significantly) or similar, if not identical, to those of a comparable polyol-polyisocyanate system of the prior art.

More particularly, the present invention allows, by a particular selection of the composition of the monomers and of the specific structure of said resin, a reduction of the viscosity in solution of the resin obtained relative to a standard prior art polyol resin. The specific resin of the invention which makes it possible to overcome the mentioned drawbacks of the prior art is based on the use of a specific mixture of monomers that make it possible to improve the solubility of the resin in the organic solvent for final application and thus to reduce the VOC content in the final formulation. This specific mixture is used for preparing a novel resin by polymerization of said mixture of monomers, which, according to a particular option, may also comprise in minor proportion a polyester resin, in particular based on fatty acid, such as an alkyd resin.

Thus, the crosslinkable system of the invention is directed toward a system with a low content of VOC and a high solids content in the final formulation, without any effect on the application conditions of the coating, in particular the viscosity remaining unaffected (constant) with a high solids content.

Among the main advantages associated with the novel system according to the present invention, mention may be made of the following:
production of PU coatings with properties inherent to this type of coating, without using isocyanates and with improved hygiene and safety conditions and with respect for the environment and at least without any (significant) effect on the essential performance qualities of said coating or maintenance of performance qualities that are similar, if not identical, to those of a comparable polyol-polyisocyanate system of the prior art,
crosslinking at room temperature, which may preferably range from −20 to 25° C., without the need for heating, with energy saving and in particular crosslinking without catalyst, more particularly in the absence of any catalyst based on heavy metals, as is the case with standard isocyanate-based PUs,
formulation of coatings, in particular paints or varnishes with high solids contents in compliance with the trends and regulations in force on VOCs,
possibility of combining a second crosslinking agent that is reactive with the hydroxyl functions generated in the beta position of the urethane group formed during the crosslinking reaction between the amine functions of a polyamine and the carbonate rings (by opening) borne by said resin of the invention and thus of increasing the crosslinking density with a hybrid system, for example by reaction with additional crosslinking agents of anhydride or blocked silane or melamine type,
possibility of using as crosslinking agents polyamines of biosourced origin, in particular fatty polyamines, and thus of increasing the content (amount) of renewable carbon in the formulation with a possibility of improving the life cycle of the product,
possibility of reducing the overall cost of the formulation,
rapid drying and maintenance of good properties of the coating film obtained, despite the low content of VOC which is generally unfavorable to such a compromise for the known systems of the prior art,
good application performance qualities and in particular, in terms of durability, including in terms of corrosion, hardness/flexibility compromise, adhesion to substrate, chemical resistance and heat resistance.

In the present invention, the term “low content of VOC” means the reduced presence of volatile organic compounds, in particular with a boiling point (b.p.) below 250° C. and a content of less than 420 g/l.

The first subject of the invention concerns said specific resin bearing cyclic carbonate groups.

Next, the invention covers a process for preparing said resin according to the invention, either such as a resin resulting directly from the polymerization of said specific mixture of monomers, or a polyester resin modified by polymerization of said mixture in the presence of this polyester resin.

Another subject of the invention is a solution in organic solvent medium of said resin.

An essential subject of the invention concerns a crosslinkable composition comprising said resin and a polyamine crosslinking agent and more particularly a coating composition.

Another subject of the invention concerns the use of said resin for crosslinkable polyurethane compositions without using isocyanates.

Finally, the present invention covers a crosslinked polyurethane resulting from said resin or from a crosslinkable composition according to the invention.

Thus, the first subject of the present invention concerns a resin that is soluble in solvent medium, in which the term “soluble in solvent medium” means that said resin can be dissolved in at least one organic solvent, which implicitly means that said resin is not crosslinked (neither insoluble or unmeltable) and thus indirectly of linear and/or branched structure, bearing cyclic carbonate end and/or side groups, in particular with a corresponding functionality of at least 2 and which resin is an oligomer and/or polymer, i.e. polymerization product, based on, with “based on” meaning: which is obtained from, a mixture a) of monomers comprising:
a1) at least one ethylenically unsaturated monomer chosen from (meth)acrylic esters derived from a C₁ to C₁₈ and preferably C₁ to C₁₂ aliphatic alcohol,
a2) at least one ethylenically unsaturated monomer a2.1) or a2.2) as defined below:
   a2.1) bearing a (meth)acrylic, vinyl or allylic ethylenic unsaturation, preferably (meth)acrylic, and (also) bearing at least one cyclic carbonate group
   a2.2) bearing an ethylenic unsaturation, preferably (meth)acrylic, vinyl or allylic, more preferentially (meth)acrylic and also bearing a reactive group which is the “precursor” of a cyclic carbonate group and with said precursor group being chemically converted by postmodification on the oligomer or polymer thus obtained before production of said oligomer or polymer (final converted) as a carbonate ring final group or as a group comprising a carbonate ring, said monomer a2.2) being selected from:
      a2.2.1): C₁ or C₂ and preferably C₁ alkyl(meth)acrylic esters, with said ester groups of said oligomer or polymer being post-transesterified (after polymerization) with an alcohol bearing a carbonate ring or
      a2.2.2): ethylenically unsaturated carboxylic acids or anhydrides, with the acid or anhydride groups of said oligomer or polymer being post-esterified with an alcohol bearing a carbonate ring or
      a2.2.3): ethylenically unsaturated epoxides with said epoxy groups of said oligomer or polymer being converted into a carbonate ring by post-reaction with CO₂,
a3) at least one ethylenically unsaturated monomer a3.1) and/or a3.2), which is preferably (meth)acrylic, as defined below:
   a3.1) comprises at least one cycloaliphatic structure or one heterocyclic structure with 5 or 6 atoms with the heteroatom being O, N or S, preferably a C₅, C₆ or C₁₀ cycloaliphatic structure optionally substituted on the ring, more preferentially selected from: norbornyl, isobornyl, isophoryl, cyclohexyl, in particular substituted cyclohexyl such as t-butylcyclohexyl, 3,3,5-trimethylcyclohexyl, dicyclopentadienyl, decahydronaphthalenyl and more particularly chosen from norbornyl, isobornyl, isophoryl, substituted cyclohexyl such as t-butylcyclohexyl, 3,3,5-trimethylcyclohexyl, dicyclopentadienyl or decahydronaphthalenyl
   a3.2) comprises at least one branched aliphatic structure comprising at least 4 and up to 18 carbon atoms with at least one quaternary carbon, with the term “quaternary carbon” meaning, in the present case, a carbon atom bonded to 4 carbon atoms via single bonding, preferably from t-butyl(meth)acrylate and/or 2,2-dimethylcaprylic acid glycidyl ester(meth)acrylate or neodecanoic acid glycidyl ester(meth)acrylate known under the name Cardura® E10 (meth)acrylate, the branched vinyl ester of versatic acid, in particular comprising 9 or 10 carbon atoms including a quaternary atom, known under the names VeoVa 9 and 10, with said monomer according to a3.2) being different from a1), more preferentially a3.2) being t-butyl(meth)acrylate and/or 2,2-dimethylcaprylic acid glycidyl ester(meth)acrylate and/or neodecanoic acid glycidyl ester(meth)acrylate,
      said monomer a3) more preferentially being a monomer according to a3.1)
a4) optionally, at least one aromatic vinyl monomer
a5) optionally at least one ethylenically unsaturated monomer, preferably (meth)acrylic, bearing at least one carboxyl group, said carboxyl group being a final group of said oligomer or polymer and thus (by definition of a5)) said carboxyl is not used as a precursor of a group bearing a carbonate ring according to the definition of a2.2.2).

According to a particular option of the invention, said mixture a) of the monomers also comprises, i.e. in addition to a1), a2), a3) and optionally a4) and optionally a5), at least one ethylenically unsaturated monomer a6), preferably (meth)acrylic, bearing at least one functional group selected from: amide, acetoacetoxy, blocked or non-blocked silane, ureido, phosphate, phosphonate, phosphinate, sulfonate, oxazoline, epoxy, hydroxyl, these last two groups being final groups of said oligomer or polymer.

According to another more particular option, said mixture of monomers a) as defined above also comprises, i.e. in addition to a1). a2), a3) and optionally a4) and optionally a5) and optionally a6) and in a minor weight proportion, at least one polyester resin, preferably based on fatty acids, in particular an alkyd resin and which may thus be chemically modified, in particular grafted, with said mixture of monomers a), preferably said polyester resin, in particular alkyd resin, being present in a proportion of less than 30% by weight relative to the total of said monomers a)+said polyester resin. Thus, according to this particular option, said mixture a) of monomers comprises said polyester resin as defined above and monomers a1) to a3), optionally with one or more optional monomers a4) to a6) and gives as a result a corresponding resin based on said polyester resin and said monomers comprising a polyester resin at least partially grafted with said monomers of said mixture a).

Depending on the type of said polyester resin, in particular alkyd resin, the minor proportion of this polyester resin, in particular alkyd resin, may be less than 20% and more particularly less than 10%.

According to a preferred particular option, the content of monomer a3) ranges from 15% to less than 30% by weight and preferably from 15% to 25% by weight relative to the total weight of said resin.

A resin defined according to the invention that is particularly preferred is one in which all the monomers a1), a2), a3) and optionally a5) and a6) as defined above are exclusively (meth)acrylic ethylenically unsaturated monomers.

According to another particular option, said mixture of monomers a) and consequently said resin resulting therefrom does not comprise any of the monomers a4), a5) and a6).

The resin according to the invention may have a content of cyclic carbonate groups expressed in mmol/g of at least 0.35 (which is equivalent to a hydroxyl number l_{OH} of about 20 expressed in mg KOH/g of dry resin) and preferably from 0.85 to 3.50 (l_{OH} equivalent of 48 to 202 mg KOH/g of dry resin).

According to a more particular definition of the resin according to the invention, said monomer a2.1) may be an ester of a monoalcohol comprising (or bearing) a cyclic carbonate group, preferably a glycerol carbonate ester, with an ethylenically unsaturated carboxylic acid and/or anhydride, more preferentially said acid and/or anhydride being selected from the acid and/or anhydride corresponding to (meth)acrylic acid, maleic and fumaric acid (anhydride), itaconic acidanhydride, tetrahydrophthalic acidanhydride, more preferentially (meth)acrylic acid. As alcohol comprising or bearing a suitable cyclic carbonate, mention may be made of glyceryl carbonate, trimethylolpropane, sorbitol or erythritol and preferably glyceryl carbonate. The monomer a2.1) may also be an allylic monomer and, as such, an example that may be mentioned is glyceryl carbonate allyl ether. It may also be a vinyl monomer, for instance 4-vinyl-1,3-dioxolanone.

One of the preferred monomers among the monomers a2.1) is glyceryl carbonate(meth)acrylate. This monomer may be prepared, for example, with a high degree of purity according to the procedure described in Example 1 of U.S. Pat. No. 7,414,147.

Among the alcohols bearing a carbonate group that are suitable for the transesterification of the C₁ and C₂ ester groups derived from the monomers a2.2.1) or suitable for the esterification of the anhydride/acid groups of the monomers a2.2.2) of said mixture a), mention may be made of glyceryl carbonate, trimethylol propane carbonate, sorbitol carbonate or erythrityl carbonate and preferably glyceryl carbonate.

The monomers a2.2.2) are chosen in particular from (meth)acrylic acid, maleic and fumaric acid (anhydride), itaconic acidanhydride, tetrahydrophthalic acid/anhydride, more preferentially (meth)acrylic acid.

Among the epoxide monomers a2.2.3) of said mixture a) that are suitable for the post-conversion of their epoxy groups into cyclic carbonates, mention may be made of all acrylic or vinyl or allylic monomers bearing an epoxy function. As particular examples of epoxidized acrylic monomers, mention may be made of glycidyl(meth)acrylate ((M)AGLY), epoxidized dicyclopentadiene methacrylate and, as allylic monomers, glycidyl allyl ether.

As examples of suitable vinylaromatic monomers a4), mention may be made of styrene and vinyltoluenes (o-, m-, p-).

As examples of suitable monomers a5), mention may be made of (meth)acrylic acid, maleic and fumaric acid (anhydride), itaconic acidanhydride, tetrahydrophthalic acidanhydride, more preferentially (meth)acrylic acid. In the case of a5), there is a distinction relative to the monomers a2.2.2) serving as support for precursor groups for the cyclic carbonates, since, in the latter case, the acid or anhydride groups remain free in the final resin. The presence and content of these acidanhydride groups will depend on the intended application and performance qualities, for example on the need or otherwise for additional crosslinking via an additional reaction of acidanhydride type with a crosslinking agent of epoxy type or the need for dispersibility of said final resin in aqueous medium.

Finally, as suitable examples of monomers a6), mention may be made, by function, of the following:
amide: acrylamide, N-methylolacrylamide, isobutoxymethylacrylamide, N-butoxy-methylacrylamide,
acetoacetoxy: ethylacetoacetoxy(meth)acrylate, acetoacetoxypropyl(meth)acrylate,
silane: (meth)acryloxypropyltrimethoxysilane, (meth)acryloxypropyltriisopropoxysilane, (meth)acryloxypropyltriethoxysilane, vinyltriethoxysilane, vinyltrimethoxysilane, vinyltris(2-methoxyethoxy)silane, vinylmethyldimethoxysilane,
ureido: ureido(meth)acrylates, such as Norsocryl® 102 or Norsocryl® 104 sold by Arkema, (meth)acrylamidoethylethyleneurea such as Sipomer® WAM II sold by Rhodia or allyl ureido monomer such as Sipomer® WAM sold by Rhodia,
phosphate: polyethylene glycol (PEG) ester phosphate(meth)acrylate (phosphoric acid monoester with PEG mono(meth)acrylate) or phosphoric acid monoester of hydroxyalkyl(meth)acrylate or phosphate allyl ether monomer (phosphoric acid monoester with allylic alcohol) or phosphoric acid monoester with vinyl alcohol,
phosphinate: methacrylic esters of hydroxyalkyl(meth)acrylate with phosphinic acid,
phosphonate: methacrylic esters of hydroxyalkyl(meth)acrylate with phosphonic acid,
sulfonate: sodium 2-acrylamido-2-methylpropane sulfonate, sodium 3-(allyloxy)-2-hydroxypropanesulfonate (Sipomer® COPS-1, sold by Rhodia), sodium vinyl sulfonate,
epoxy (with difference vs a2.2.3): no conversion of the epoxy functions into carbonates): glycidyl(meth)acrylate ((M)AGLY) or epoxidized dicyclopentadienyl methacrylate, glycidyl allyl ether. The advantage of such free epoxy groups in the resin is the possibility of a double crosslinking system via urethane bonds (carbonate-amine of polyamine) and amine-epoxy (polyamine amine) with the same polyamine crosslinking agent. Such a two-pack (2k) system that is crosslinkable by double crosslinking reaction is a particular system also covered by the present invention,
hydroxyl: hydroxyalkyl(meth)acrylate, with the alkyl preferably being an ethyl. propyl or butyl. The advantage of this presence of a free OH function is linked to the possibility of additional crosslinking via melamine or silanes.

More preferentially, the monomers a6) bear functions from among: acetoacetoxy, blocked silane, ureido, phosphate, phosphinate, phosphonate, epoxy or hydroxyl.

In general, the various monomers a5) and a6) are chosen such that their respective functional groups cannot react together, including the case where several monomers a6) are present but with different functional groups that do not react with each other, and that do not react in general with the groups of the monomers a2).

In the case where monomers of branched structure are used, as monomers a1), they are different from the monomers defined according to a3.2) optionally used.

It is clear, according to the invention, that said resin according to the invention is obtained by polymerization reaction, in particular via a radical route in solution in organic solvent medium of said mixture of monomers a) as defined above.

As regards the number-average molecular masses Mn as measured by GPO, expressed in polystyrene equivalents in THF, they may range for Mn from 500 to 5000 and preferably from 500 to 4000. More particularly, the Mn of the resin of the invention may range from 500 to 4000 and more preferentially from 500 to 3000 and the Mn of said polyester resin, in particular alkyd resin, when it is present according to a particular option in said mixture a) of monomers for preparing the corresponding resin according to the invention, may range from 500 to 2000 and more preferentially from 750 to 1500.

The second subject of the invention covers a process for preparing a resin as defined above according to the invention, which comprises at least one step of polymerization i), preferably via a radical route, of a mixture of monomers a) with a2) being selected from the monomers a2.1) or a2.2) as defined above.

According to a more particular mode, said process for preparing the resin comprises at least one step of polymerization i), preferably via a radical route, of said mixture of monomers a) comprising a monomer a2) selected from the monomers as defined according to a2.2) and an additional step ii) of chemical modification of said precursor groups into groups bearing a carbonate ring, as defined above in a2.2).

Next, according to another particular option of said process according to the invention, said process may comprise the polymerization of said mixture of monomers a), which also comprises (i.e. in addition to a1), a2) and a3) and optionally at least one from among a4), a5) or a6)), in minor proportion said polyester resin, in particular alkyd resin, preferably in a content of less than 30% by weight relative to the total weight of polyester resin+monomers a), with polymerization and optional grafting, preferably radical-mediated, in solvent medium. This means that what characterizes said process according to this particular option is the fact that said mixture of monomers a) also comprises, in minor amount, said polyester resin. The term “grafting” more particularly means here grafting by covalent bonding between said polyester resin, in particular alkyd resin, and said monomers of the mixture a), i.e. the monomers a1), a2), a3) and optionally at least one of the monomers a4), a5) or a6), by copolymerization of the monomers of said mixture a), more particularly with the optional ethylenic unsaturations of said polyester resin, which is particularly the case for an alkyd resin or by grafting onto labile hydrogens of said polyester structure.

In the case of presence in said mixture a) of monomers a2.2) bearing precursor groups of said groups comprising cyclic carbonates, said process also comprises a step of post-modification of said precursor groups into cyclic carbonate final groups as defined above for the resin of the invention and for the monomers a2.2.1), a2.2.2) and a2.2.3).

The number-average functionality of cyclic carbonate groups per chain of said resin of the invention is at least 2.

Another subject of the invention is a solution of resin in an organic solvent, which solution comprises at least 50%, preferably at least 60%, more preferentially from 60% to 95% and even more preferentially from 68% to 90% by weight of said resin, as defined according to the invention above or resin obtained via a process as defined above according to the invention.

According to a particular option in said solution, said organic solvent is selected from: ketones, in particular acetone, butanone, methyl ethyl ketone, methyl amyl ketone, methyl isobutyl ketone, cyclohexanone, acetic and propionic acid esters, in particular ethyl acetate, butyl acetate, isoamyl acetate, pentyl acetate, ethyl 3-ethoxypropionate, esters of dicarboxylic acids, such as adipic acid, glutaric acid and succinic acid, and of methanol, ethanol, (iso)propanol or (iso)butanol, aromatic solvents such as heavy or light petroleum fractions having respective boiling point ranges of 180-215° C. and 150-180° C., toluene and xylene and isomers thereof, aliphatic solvents such as isophorone or heptane, alcohols, in particular ethylene glycol (EG), propylene glycol (PG), ethanol, propanol, butanol, pentanol, hexanol, heptanol and the corresponding isomers thereof or glycerol, glycol ethers, in particular 2-butoxyethanol (Butyl Cellosolve), propylene glycol methyl ether acetate (Dowanol® PMA), propylene glycol methyl ether (Dowanol® PM), propylene glycol n-butyl ether (Dowanol® PnB), propylene glycol n-propyl ether (Dowanol® DPM), dipropylene glycol n-butyl ether (Dowanol® DPnB), solvents with heteroatoms, in particular dimethyl sulfoxide (DMSO), N-ethylpyrrolidone (NEP), tetrahydrofuran (THF) or binary and ternary mixtures of said solvents mentioned above, on condition that there is compatibility between said solvents. Compatibility between 2 or 3 solvents means the absence of demixing (separation into two phases at least for binary and ternary mixtures) at room temperature at the proportions used.

Another subject of the invention concerns a crosslinkable composition which comprises an organic solvent and at least one resin as defined above according to the invention or obtained via a process as defined above according to the invention and at least one crosslinking agent chosen from polyamines present during the crosslinking. More particularly, this composition comprises said polyamine, which has a functionality of at least 2 and said polyamine is selected from polyamine monomers and/or oligomers, preferably with said oligomers having a number-average mass Mn not exceeding 1500 and more preferentially not more than 1000. Even more particularly, said crosslinkable composition comprises a polyamine as described above, which bears primary or secondary amine functions and is selected from polyamines of aliphatic or cycloaliphatic structure and optionally of aromatic structure according to the final use. The functionality of said polyamine is adapted to that of said resin of the invention as cyclic carbonates. When said resin has a functionality (number-average) of 2, in this case the functionality of said polyamine must be greater than 2 for the crosslinking. Mixtures of polyamines may be used, in which case the functionality under consideration will be the number-average of said mixture of polyamines. According to a more particular option, said polyamine is a C₁₂ to C₅₄ and preferably C₁₂ to C₂₂ fatty polyamine and/or is a polyamine based on polyether, for example of Jeffamine® type and/or a polyamine based on polyalkyleneimines and/or a polyamine based on acrylic oligomers with, for said polyamines based on polyethers, polyalkyleneimines or acrylic oligomers, an Mn of less than 1000.

Said polyamine is an acrylic oligomer which results from the copolymerization of an acrylic monomer bearing a primary or secondary amine function with another acrylic comonomer. Said acrylic monomer or comonomer is in particular a methacrylate, so as to avoid Michael addition reactions which would lead to a crosslinked structure, otherwise said amine function is in blocked form and not reactive with an acrylate if said monomer is an acrylate. Said oligomer may be used with the amine function in blocked form, otherwise with the function unblocked after production of said oligomer and depending on the need during the application.

In particular, in the case of a crosslinkable composition which must behave like a one-pack composition (noted 1k), i.e. stable on storage at room temperature before use in application, said polyamine may be in a form blocked with a blocking agent and may be deblocked, for example, by heating after drying the film resulting therefrom. The amine groups of said polyamines may thus be blocked in the form of blocked groups such as: aldimines, ketimines, oxazolidines, hexahydropyrimidines, tetrahydroimidazoles, and mixtures thereof.

In the case where said polyamine is not blocked, said crosslinkable composition behaves like a two-pack (2k) composition with a system which changes as the reaction proceeds. The 2k composition is thus unstable on storage with a limited open time, and consequently the addition of said polyamine in unblocked form must take place just before the application and final use in place at the site of application. The ratio of the amine (primary or secondary) groups to the carbonate groups is adjusted such that there is no excess of amine, with ratios that may range up to 1 and preferably range from 0.8 to 1.

According to a preferred option, said crosslinkable composition has a solids content on the basis of said resin as defined above or as obtained via a process as defined above according to the invention and of said polyamine crosslinking agent, of greater than 20%, preferably ranging from 60% to 85% and more preferentially from 65% to 85% by weight. This means that this solids content represents the content of crosslinkable resin binder, resin+polyamine crosslinking agent, according to the invention. In the case of compositions that are varnishes, this content corresponds perfectly to the common content of solids of the varnish, which corresponds to the content of crosslinkable binder (resin+crosslinking agent). In the case of paints or of other crosslinkable compositions and in the case of the presence of other solids such as fillers, additives and/or pigments, the real solids content corresponds to the content of crosslinkable resin binder according to the invention (resin+polyamine crosslinking agent) with, in addition, the content of other additives and fillers or pigments, which may vary depending on the type of application. However, the solids content corresponding to the crosslinkable resin binder of the invention (resin+polyamine crosslinking agent) is preferably in the range greater than 20% by weight of the composition and is more particularly from 60% to 85% by weight.

According to an even more preferred case, the crosslinkable composition according to the invention is a coating composition. more particularly a protective coating and more particularly an anticorrosion coating and even more particularly a paint or a varnish.

Coatings of this type may serve in particular for protective coating applications, in particular top coats with high resistance to wear and abrasion and/or intensive use under severe typical continuous external climatic conditions, in particular in the following fields of application: construction and renovation, in the railway sector (High-Speed trains, subway trains, local mainline trains), motor vehicle, road transport, naval, aeronautic, agricultural machinery, public works machines, windmills, oil platforms, containers, metal buildings, metal armatures, building or coil.

The invention also covers the use of at least one resin as defined above or obtained via a process as defined according to the invention for the preparation of polyurethanes that are crosslinked without any use of isocyanate. This use applies more particularly to coatings, preferably to coatings for substrates selected from: metal, wood including agglomerate, cardboard, concrete, ceramic, glass, plastic or composite.

A final subject covered by the present invention relates to a crosslinked polyurethane which results from a resin as defined above or obtained via a process of the invention or from a crosslinkable composition as described above according to the invention.

The examples that follow are given as illustrations of the invention and of its advantages, without implying any limitation of its scope.

### EXPERIMENTAL SECTION

### 1) Starting Materials Used

these materials are presented in Table 1 below

TABLE 1
starting materials used

| | Abbreviated | | |
|---|---|---|---|
| Product chemical | name used | | Function |
| name or commercial | in the | | in resin |
| name | description | Supplier | composition |
| Styrene | STY | Total | Monomer a4) |
| Butyl acrylate | ABU | Arkema | Monomer a1) |
| Methyl methacrylate | MAM | Arkema | Monomer a1) |
| Glyceryl carbonate | GCM | — | Monomer a2) |
| methacrylate* | | | |
| Isobornyl | MAISOBOR | Evonik | Monomer a3.1) |
| methacrylate | | | |
| 2-Hydroxyethyl | HEA | BASF | Standard resin |
| acrylate | | | monomer |
| Luperox ® DI | DTBP | Arkema | Radical |
| | | | generator |
| Luperox ® 26 | TBPO | Arkema | Radical |
| | | | generator |
| Ektapro ® EEP | EEP | Aldrich | Solvent |
| (ethyl | | | |
| 3-ethoxypropionate) | | | |
| Butyl acetate | — | Brenntag | Solvent |
| Ethylenediamine | EDA | Aldrich | Crosslinking |
| | | | agent C) |
| Tolonate ® HDT-LV2 | — | Perstorp | Isocyanate |
| | | | crosslinking |
| | | | agent for |
| | | | standard resin |
| TIB KAT 218 | DBTDL | TIB | Catalyst for |
| (Dibutyltin | | Chemicals | standard |
| dilaurate) | | | polyol- |
| | | | isocyanate |
| | | | system |

*GCM: according to Example 1 of U.S. Pat. No. 7,414,147, other name GCM: propylene carbonate methacrylate

### 2) Preparation of Resins Bearing Cyclic Carbonate Functions

The examples presented below illustrate this preparation according to the invention and with reference comparative examples.

### Example 1 According to the Invention

Ethyl 3-ethoxypropionate (218 g) is placed in a 2000 mL reactor. While flushing with nitrogen, the reactor is brought to 150° C. In parallel, 148 g of styrene, 124 g of butyl acrylate, 9.8 g of methyl methacrylate, 239 g of propylene carbonate methacrylate (or glyceryl carbonate methacrylate) and 130 g of isobornyl methacrylate are mixed together. A solution of di-tert-butyl peroxide DTBP (24.7 g) and tert-butyl peroctoate TBPO (9.8 g) in ethyl 3-ethoxypropionate (47 g) is also prepared. These two preparations are then introduced in parallel into the reactor over a period of 7 hours 30 minutes, the temperature being maintained at 150° C. through this period while flushing with nitrogen. At the end of these additions, the medium is kept at the same temperature for 1 hour before being cooled to room temperature. The final solids content of the resin is then 70.1% and its viscosity, measured at 25° C. according to standard ISO 3219, is 12.5 Pa·s (125 P).

### Comparative Example 2

### Outside the Invention

The conditions are identical to those described in Example 1, except that the composition of the monomer mixture is different as indicated in Table 2 below.

The final resin obtained has a solids content of 70.3% and a viscosity at 25° C. of 32.3 Pas (323 P). By diluting with ethyl 3-ethoxypropionate, the solids content may be reduced to 69.0%, and the measured viscosity is 31.2 Pa·s (312 P).

### Comparative Example 3 Outside the Invention

This test was performed with the ratio of the comonomers STY/ABU/MAM kept constant (see Table 2) relative to the test of Example 1 according to the invention.

### Comparative Examples 4 and 5 Outside the Invention

The conditions are identical to those described in Example 1, except that the composition of the monomer mixture is different as indicated in Table 2 below.

TABLE 2
Composition of the resins prepared

| | Example 1 | Example 2 | Example 3 | Example 4 | Example 5 |
|---|---|---|---|---|---|
| | invention | comparative | comparative | comparative | comparative |
| Composition | | | | | |
| (weight %) | | | | | |
| STY | 22.7 | 22.7 | 33.2 | 22.7 | 22.7 |
| ABU | 19.0 | 19.0 | 27.8 | 19.0 | 19.0 |
| MAM | 1.5 | 21.5 | 2.2 | 35.4 | 35.4 |
| GCM | 36.8 | 36.8 | 36.8 | — | 22.9 |
| MAISOBOR | 20.0 | — | — | — | — |
| HEA | — | — | — | 22.9 | |
| AA | — | — | — | — | — |
| Characteristics | | | | | |
| Carbonate | 2.0 | 2.0 | 2.0 | 2.0* | 1.2 |
| functionality | | | | | |
| (mmol/g)** | | | | | |
| Solids content (%) | 70.1 | 70.3 | 69.5 | 68.7 | 69.3 |
| Viscosity | 12.5/125 | 32.3/323 | 17.0/170 | 5.2/52 | 14.1/141 |
| (Pa · s/P) | | | | | |
| Appearance | Clear | Slightly cloudy | Cloudy | Clear | Clear |

*OH functionality (mmol/g)
**per g of dry resin

### 3) Preparation of 2k Crosslinkable Compositions and Crosslinking

3.1) Formulation Used: See Table 3 Below

TABLE 3
compositions of the crosslinkable 2k formulation (in g) and characteristics

| | Varnish 1 | Varnish 2 | Varnish 3 | Varnish 4 | Varnish 5 |
|---|---|---|---|---|---|
| | (invention) | (comparative) | (comparative) | (comparative) | (comparative) |
| Resin Example 1 | 50 | / | / | / | / |
| Resin Example 2 | / | 50 | / | / | / |
| Resin Example 3 | / | / | 50 | / | / |
| Resin Example 4 | / | / | / | 50 | / |
| Resin Example 5 | / | / | / | / | 50 |
| Amine (Ethylendiamine (EDA)) | 2.11 | 2.11 | 2.09 | / | 1.17 |
| Isocyanate (Tolonate HDT-LV2) | / | / | / | 11.44 | / |
| Butyl acetate | 9.5 | 14.3 | 12.2 | 11.8 | 13.6 |
| Catalyst (1% solution of | / | / | / | 1.37 | / |
| DBTDL in butyl acetate) | | | | | |
| Viscosity (mPa · s), | 288 | 301 | 285 | 285 | 284 |
| CAP 1000 | | | | | |
| (spindle No. 3) T = 25° C. | | | | | |
| (ISO 2884-1) | | | | | |
| Density at 20° C. according | 1.04 | 1.03 | 1.04 | 1.05 | 1.05 |
| to ISO 2811 | | | | | |
| % solids content (ISO 3251) | 60.4 | 56.1 | 57.3 | 81.4 | 55.8 |
| VOC (g/l) | 412 | 452 | 444 | 406 | 464 |

3.2) Operating Conditions for Preparing the Formulations and for the Crosslinking

The general procedure for preparing the varnish formulations is as follows:

The amounts of binders (resin and crosslinking agent) as prepared above are poured into a cylindrical container. The medium is then stirred (with a Dispermat® CV machine) at room temperature (20-25° C.). This mixture is then diluted with butyl acetate so as to obtain a high-gradient viscosity (viscosity CAP 1000, spindle No. 3, T=25° C.) of 280±20 mPa·s. The varnish formulation is then applied to a steel support of 0046 type with a Barecoater applicator (speed 3=20 mm/s) so as to obtain a controlled dry thickness of 30-40 μm. The varnish thus applied is conditioned at a temperature of 23° C. under a controlled relative humidity (RH) of 50%.

### 4) Tests and Methods Used for Characterizing the Resins and the Performance Qualities of the Crosslinked Coatings Obtained (Operating Conditions)

4.1) Measurement of the Solids Content of a Solvent-Based Resin (Method ISO 3251)

1 g of resin is introduced into and correctly spread in an aluminum crucible. The crucible is then placed in an oven at 125° C. and dried for 1 hour. The solids content is obtained by calculating the ratio of the dry mass to the mass of initial resin.

4.2) Measurement of the Viscosity (Standard ISO 3219)

The viscosity of the solvent-based resins (in solution) is measured using a Brookfield LVDV-I+ machine, spindle S34, at 25° C.

4.3) Dust-Free Drying Test: According to Method ISO 1517

The principle is as follows: using calibrated fine glass beads (granulometry 125/250 μm), the moment at and beyond which they no longer remain bonded to the support covered with paint or varnish is determined. The support covered with paint or varnish is placed in the air-conditioned room (50% RH/23° C.). After a certain time, at the end of which it has considered that the coating has sufficiently reacted, a spatula-full of glass beads (about 0.5 g) is taken and poured onto the paint (or varnish) applied using a small tube 10 cm long. After 10 seconds, the support is inclined by 20° and the glass beads are removed using a fine brush. If they do not remain bonded. the paint is considered to be dry “dust-free” at the corresponding drying time (after application). In the contrary case, another test is performed a few minutes later and so on until no beads stick to the surface of the coating to note the dust-free drying time.

4.4) Hardness Test: According to Method ISO 1522

This is a Persoz hardness test performed at 23° C. and at 50% relative humidity. The varnishes are applied onto QD36 type steel (Q-Panel) and then left under the conditions described above (23° C. and 50% relative humidity) for a period of 7 days. The measurements are taken after 1 day, 4 days and 7 days of drying.

### 5) Performance Qualities of Crosslinked 2k Coatings (Varnish)

The application performance qualities are presented in the comparative Table 4 below.

TABLE 4
summary of the performance qualities of the 2k coatings (varnishes) obtained

| | Varnish 1 | Varnish 2 | Varnish 3 | Varnish 4 | Varnish 5 |
|---|---|---|---|---|---|
| | invention | comparative | comparative | comparative | comparative |
| Dry film thickness (μm) | 35 ± 1 | 35 ± 1 | 34 ± 1 | 39 ± 1 | 35 ± 1 |
| Dust-free drying | 0 h 57 | 0 h 50 | 0 h 37 | 1 h 12 | 1 h 18 |
| Persoz hardness 1 day | 112 | 89 | 110 | 89 | 79 |
| Persoz hardness 4 days | 182 | 112 | 125 | 190 | 116 |
| Persoz hardness 7 days | 194 | 156 | 200 | 210 | 155 |

1. A resin that is soluble in solvent, bearing cyclic carbonate end and/or side groups, having a functionality of at least 2, wherein said resin is an oligomer and/or polymer, based on a mixture a) of monomers comprising:
a1) at least one ethylenically unsaturated monomer selected from the group consisting of (meth)acrylic esters derived from a C₁ to C₁₈ aliphatic alcohol,
a2) at least one ethylenically unsaturated monomer a2.1) or a2.2) wherein:
a2.1) bears a (meth)acrylic, vinyl or allylic ethylenic unsaturation and (also) bears at least one cyclic carbonate group
a2.2) bears an ethylenic unsaturation, vinyl or allylic, and also bears a reactive group which is the precursor of a cyclic carbonate group and with said precursor group being chemically converted by postmodification on the oligomer or polymer thus obtained before production of said oligomer or polymer (final converted) as a carbonate ring final group or as a group comprising a carbonate ring, said monomer a2.2) being selected from:
a2.2.1): C₁ or C₂ alkyl(meth)acrylic esters, with said ester groups of said oligomer or polymer being post-transesterified (after polymerization) with an alcohol bearing a carbonate ring or
a2.22): ethylenically unsaturated carboxylic acids or anhydrides, with the acid or anhydride groups of said oligomer or polymer being post-esterified with an alcohol bearing a carbonate ring or
a2.2.3): ethylenically unsaturated epoxides with said epoxy groups of said oligomer or polymer being converted into a carbonate ring by post-reaction with CO₂,
a3) at least one ethylenically unsaturated monomer a3.1) and/or a3.2), wherein:
a3.1) comprises at least one cycloaliphatic structure or one heterocyclic structure with 5 or 6 atoms with the heteroatom being O, N or S, substituted on the ring, dicyclopentadienyl, decahydronaphthalenyl
a3.2) comprises at least one branched aliphatic structure comprising at least 4 and up to 18 carbon atoms with at least one quaternary carbon with such monomer a3.2 being different from a1,
a4) optionally, at least one aromatic vinyl monomer
a5) optionally at least one ethylenically unsaturated monomer, bearing at least one carboxyl group, said carboxyl group being a final group of said oligomer or polymer and thus (by definition of a5)) said carboxyl is not used as a precursor of a group bearing a carbonate ring according to the definition of a2.2.2).

2. The resin as claimed in claim 1, wherein said mixture of monomers a) also comprises at least one ethylenically unsaturated monomer a6), bearing at least one functional group selected from the group consisting of: amide, acetoacetoxy, blocked or unblocked silane, ureido, phosphate, phosphonate, phosphinate, sulfonate, oxazoline, epoxy, and hydroxyl, the last two groups being final groups of said oligomer or polymer.

3. The resin as claimed in claim 1 wherein said mixture a) also comprises, in a minor weight proportion (relative to the weight of said mixture) at least one polyester resin, said polyester resin being present in a content of less than 30% by weight relative to the total weight of said monomers a)+said polyester resin.

4. The resin as claimed in claim 1 wherein the content of cyclic carbonate groups expressed in mmol/g is at least 0.35.

5. The resin as claimed in claim 1 wherein said monomer a2.1) is a monoalcohol ester comprising a cyclic carbonate group, said acid and/or anhydride being selected from the group consisting of the acid and/or anhydride corresponding to (meth)acrylic acid, maleic and fumaric acid (anhydride), itaconic acidanhydride, and tetrahydrophthalic acid/anhydride.

6. The resin as claimed in claim 1 wherein all the monomers a1), a2), a3) and optionally a5) and a6) are exclusively (meth)acrylic ethylenically unsaturated monomers.

7. The resin as claimed in claim 1 wherein the weight content of said monomer a3) in said resin ranges from 15% to less than 30%.

8. A process for preparing a resin of claim 1 wherein said process comprises at least one step of polymerization i), of said mixture of monomers a) with a2) selected from the monomers a2.1) or a2.2).

9. The process as claimed in claim 8, comprising at least said step of polymerization i), of said mixture of monomers a) comprising a monomer a2) selected from the monomers as defined according to a2.2) and an additional step ii) of chemical modification of said precursor groups into groups bearing a carbonate ring.

10. The process of claim 8 comprising the step of the polymerization of said mixture of monomers a), which also comprises in minor proportion said polyester resin, with polymerization and optional grafting in solvent medium.

11. \ solution of resin in an organic solvent, comprising at least 50%, by weight of resin, as defined according claim 1.

12. The solution of claim 11, characterized in that said organic solvent is selected from the group consisting of: ketones, acetic and propionic acid esters, butyl acetate, isoamyl acetate. pentyl acetate, ethyl 3-ethoxypropionate, esters of dicarboxylic acids and of methanol, ethanol, (iso)propanol or (iso)butanol, aromatic solvents and isomers thereof, aliphatic solvents, alcohols, or glycerol, glycol ethers, propylene glycol methyl ether acetate, propylene glycol methyl ether, propylene glycol n-butyl ether, propylene glycol n-propyl ether, dipropylene glycol n-butyl ether, solvents with heteroatoms chosen from the group consisting of dimethyl sulfoxide (DMSO), N-ethylpyrrolidone (NEP), tetrahydrofuran (THF) or binary and ternary mixtures of said solvents.

13. A crosslinkable composition comprising an organic solvent, at least one resin of claim 1 and at least one crosslinking agent chosen from polyamines.

14. The composition of claim 13, wherein said polyamine has a functionality of at least 2 and wherein said polyamine is selected from the group consisting of polyamine monomers and/or oligomers.

15. The composition as claimed in claim 13 wherein said polyamine bears primary or secondary amine functions and selected from the group consisting of polyamines of aliphatic or cycloaliphatic and optionally aromatic structure.

16. The composition as claimed in claim 13 wherein said polyamine is at least one polyamine selected from the group consisting of a C₁₂ to C₅₄ fatty polyamine, polyamine based on polyether, and/or polyamine based on polyalkyleneimine, polyamine based on acrylic oligomers having, for said polyamines based on polyethers, polyalkyleneimines or acrylic oligomers, an Mn of less than 1000.

17. The composition as claimed in characterized in that claim 13 wherein said polyamine is an acrylic oligomer resulting from the copolymerization of an acrylic monomer bearing a primary or secondary amine function.

18. The composition as claimed in claim 13 wherein said composition is a composition with one-pack (1k) behavior, with said polyamine being blocked with a blocking agent.

19. The composition as claimed in claim 13 wherein the solids content of said resin and of said polyamine crosslinking agent is greater than 20%.

20. The composition as claimed in claim 13 which is a protective coating.

21. The composition as claimed in claim 13 having a content of VOC (volatile organic compounds) of less than 420 g/l.

22. (canceled)

23. (canceled)

24. (canceled)
